(19) United States
(12) Patent Application Publication
(10) Pub. No.: US 2009/0154152 A1
(43) Pub. Date: Jun. 18, 2009

(54) SYSTEM, METHOD, AND ARCHITECTURE FOR MULTICELLED ELECTROLUMINENSE PANEL

(76) Inventors: David Hoch, Belmont, MA (US); Ed Despard, Newton, MA (US)

Correspondence Address: Richman and Associates, PO Box 3333, La Jolla, CA, 92038-3333, US

(21) Appl. No.: 11/953,010

(22) Filed: Dec. 7, 2007

(51) Int. Cl. F21S 2/00

(52) U.S. Cl. 362/227

(57) ABSTRACT

Embodiments of electronic lighting architecture are described generally herein. Other embodiments may be described and claimed.

### TECHNICAL FIELD

Various embodiments described herein relate generally to electronic lighting, including architecture, systems, and methods used in electronic lighting.

### BACKGROUND INFORMATION

A user may employ an electronic lighting system to generate various user perceptible images including fixed or variable images. The user may further employ the electronic lighting system to generate various user perceptible images including fixed or variable images having monochrome or multiple frequency light.

### BRIEF DESCRIPTION OF THE DRAWINGS

FIG. 1 is a system diagram of electronic lighting architecture according to various embodiments.

FIG. 2 is a system diagram of another electronic lighting architecture according to various embodiments.

FIG. 3A is a diagram of an electronic lighting panel architecture according to various embodiments.

FIG. 3B is a side view of layers of an electronic lighting panel according to various embodiments.

FIG. 3C is a side view of layers of an electronic lighting panel architecture.

FIG. 4A is a side view of layers of an electronic sensing architecture according to various embodiments.

FIG. 4B is a side view of a vertical sensing layer of an electronic sensing architecture.

FIG. 4C is a side view of a horizontal sensing layer of an electronic sensing architecture.

FIG. 5A is a side view of layers of a multi-celled electroluminescent (“EL”) architecture.

FIG. 5B is a front view of an insulation layer of a multi-celled electroluminescent (“EL”) architecture.

FIG. 5C is a front view of a silver ink conductive layer of a multi-EL architecture.

FIG. 5D is a front view of a dielectric layer of a multi-celled EL architecture.

FIG. 5E is a front view of a phosphor layer of a multi-celled EL architecture.

FIG. 5F is a front view of a polyethylene terephthalate (“PET”) film with Indium tin oxide (“ITO”) layer of a multi-celled EL architecture.

FIG. 5G is a front view of a silkscreen on polyethylene terephthalate (“PET”) layer of a multi-celled EL architecture.

FIG. 5H is a diagram of several panels coupled together according to various embodiments.

FIG. 6 is a front view of an aluminum foil layer of a shield architecture.

FIG. 7 is a component protection layer (CPL) of an electronic lighting panel architecture.

FIG. 8A is a partial view of a top section of a printed circuit board (“PCB”) of an electronic lighting panel architecture.

FIG. 8B is a partial view of two EL panels coupled to PCB panels electrically coupled according to various embodiments.

FIG. 8C is a partial view of four EL panels coupled to PCB panels electrically coupled according to various embodiments.

FIG. 8D is a partial view of four EL panels coupled to PCB panels electrically coupled and covered with a CPL layer according to various embodiments.

FIG. 8E is a partial view of four EL panels coupled to PCB panels electrically coupled and covered with a CPL, polychlorotrifluoroethylene (PCTFE) or ACLAR®, and FOIL layer according to various embodiments.

FIG. 8F is a partial view of four EL panels coupled to PCB panels electrically coupled and covered with a CPL, polychlorotrifluoroethylene (PCTFE) or ACLAR®, FOIL, and PET layer according to various embodiments.

FIG. 8G is a partial view of eight EL panels coupled to PCB panels electrically coupled according to various embodiments.

FIG. 9A is a diagram of low power transmission for a PCB of an electronic lighting panel architecture according to various embodiments.

FIG. 9B is a diagram of high power transmission for a PCB and processor configuration of an electronic lighting panel architecture according to various embodiments.

FIG. 9C is a diagram of another high power transmission for a PCB and processor configuration of an electronic lighting panel architecture according to various embodiments.

FIG. 10 is a flow diagram illustrating a panel coupling method according to various embodiments.

FIG. 11 is a flow diagram illustrating a sensing method according to various embodiments.

FIG. 12 is a block diagram of a power supply according to various embodiments.

FIG. 13 is a diagram of a section of PCB including EL panel power couplings according to various embodiments.

FIG. 14 is another partial view of a top section of a printed circuit board (“PCB”) of an electronic lighting panel architecture.

FIG. 15 is a block diagram of an article according to various embodiments.

FIG. 16 is a flow diagram illustrating a sensor monitoring method according to various embodiments.

### DETAILED DESCRIPTION

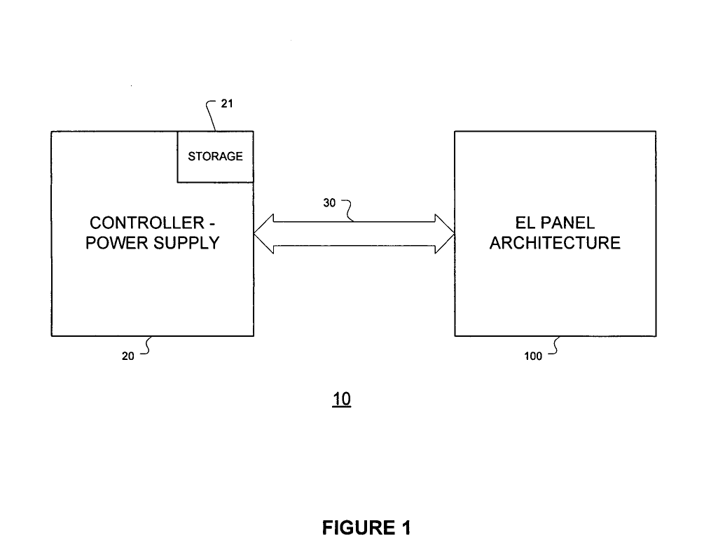

FIG. 1 is a system diagram of electronic lighting architecture 10 according to various embodiments. Architecture 10 includes controller/power supply 20 coupled to the electroluminescent (EL) panel architecture 200. The controller/power supply 20 may generate a power signal and data signal that is coupled to the EL panel architecture 200 via one or more electrical pathways 30. The controller 20 may generate data signals transmitted via the electrical pathways 30 to control the operation of the EL panel architecture 200 including controlling two or more individually controllable cells or pixels. The controller may provide the data signals separate from power signals or overlaid on the power signal. The controller/power supply 20 may include a storage device 21. The storage device 21 may be used to store the cell or pixel 125 energization levels applied to cells or pixels 125 for one or more EL panels 120. The storage device 21 may also store signals received from the EL panel architecture 100. The storage device 21 may also device capable of storing digital information including a read only memory (RAM), optical drive, magnetic drive, tape drive, and other digital storage devices.

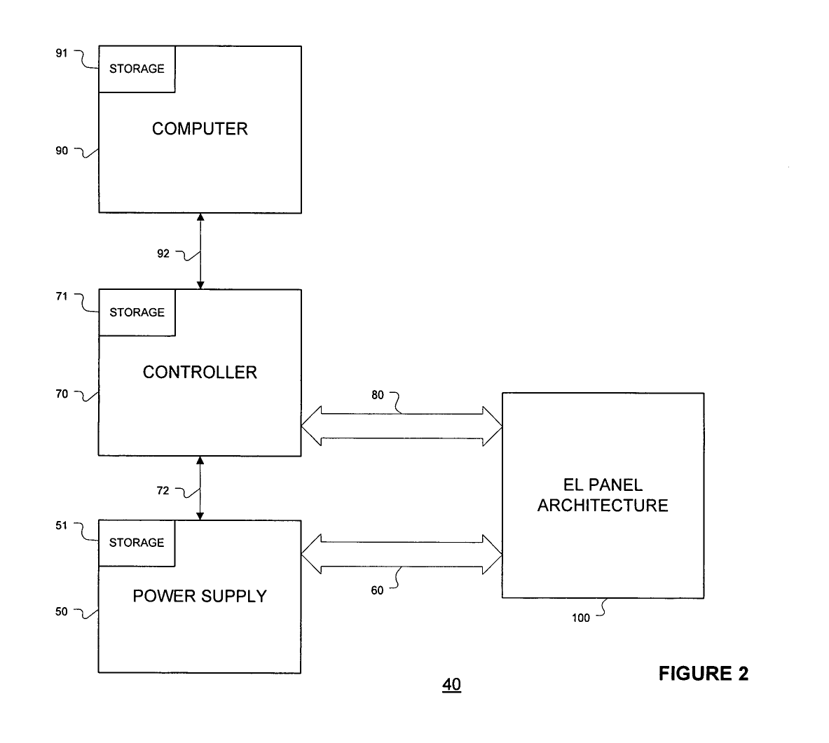

FIG. 2 is a system diagram of another electronic lighting architecture 40 according to various embodiments. The architecture 40 includes a computer 90, a controller 70, a power supply 50, and EL panel architecture 100. The controller 70 may receive control signals 92 via the computer 90 and generate one or more control signals 80 for the EL panel architecture 100. The control signals 80 may control the energy generated by one or more cells or pixels of the EL panel architecture 100. The power supply may generate one or more power signals 60 for the EL panel architecture 100. In an embodiment the power signals 60 may include a high voltage signal and one or more low voltage signals.

The controller 70 may communicate signals 72 to the power supply 50. The control signals 72 from the controller 70 may control the voltage level or frequency of the high voltage signal 60 generated by the power supply 50. The computer 90, controller 70, and power supply 50 may include a storage device 91, 71, 51. The storage device 91, 71, 51 may be used to store the cell or pixel 125 energization levels applied to cells or pixels 125 for one or more EL panels 120. The storage device 91, 71, 51 may also store signals received from the EL panel architecture 100. The storage device 91, 71, 51 may also device capable of storing digital information including a read only memory (RAM), optical drive, magnetic drive, tape drive, and other digital storage devices. The storage device 91, 71, or 51 may also be used to store signals transmitted between the computer 90, controller 70, or power supply 50.

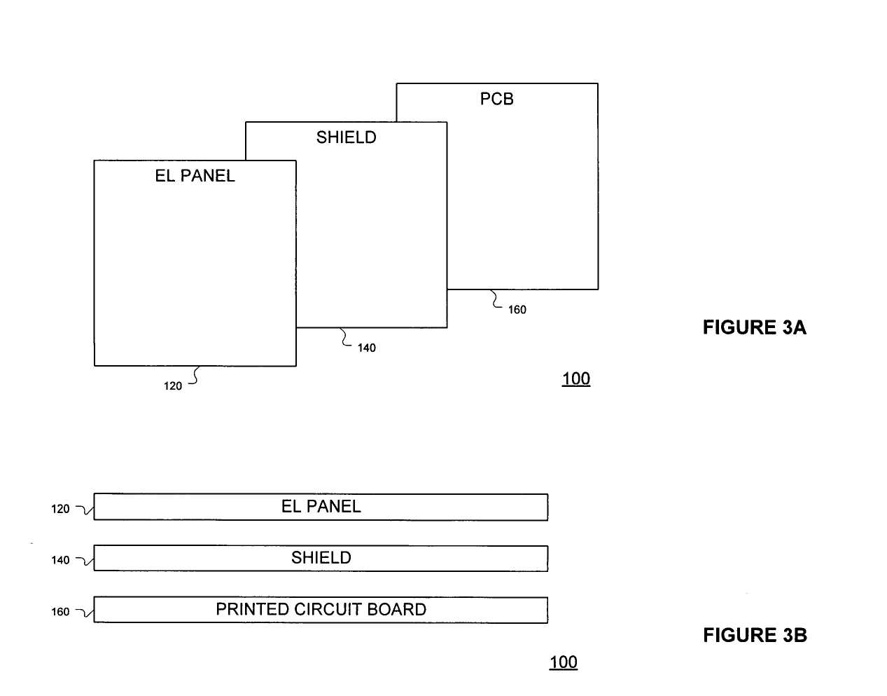

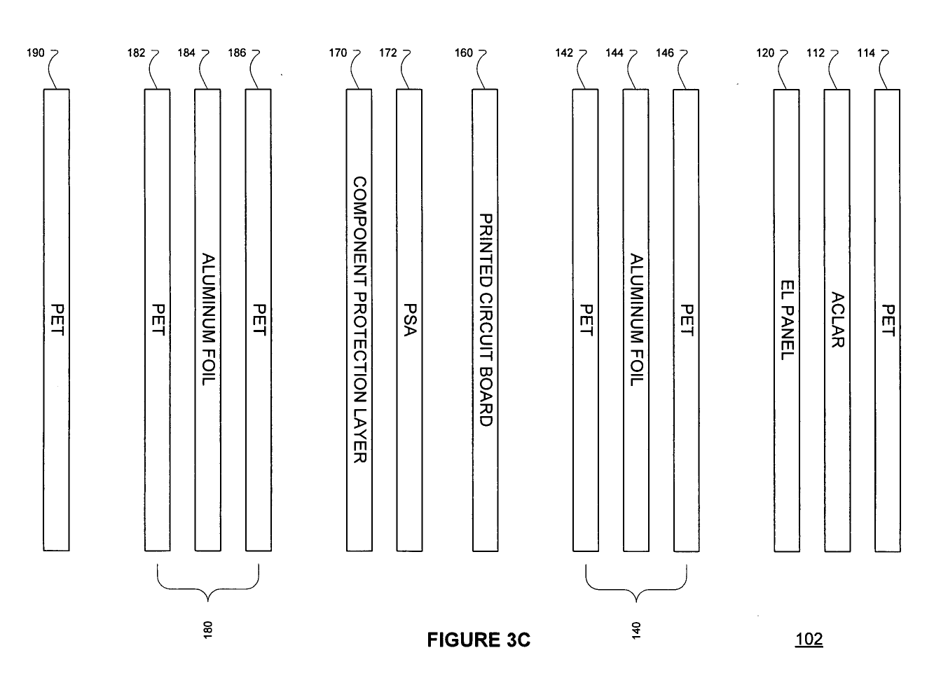

FIG. 3A is a diagram of an embodiment of an electronic lighting panel architecture 100 according to various embodiments. FIG. 3B is a side view of layers of an electronic lighting panel according to various embodiments. The architecture 100 includes an EL panel 120, electrical shield 140, and PCB 160. In an embodiment the EL panel includes common electrode and a separate coupling for each pixel or cell of the plurality of cells of the EL panel. The shield 140 may electrically shield the PCB 160 from the EL panel 120. As shown in FIG. 3B the EL panel 120, shield 140, and the PCB 160 overlap over a substantial portion.

FIG. 3C is a side view of layers of an electronic lighting panel architecture 102. Architecture 102 includes a polyethylene terephthalate (PET) layer 114, a polychlorotrifluoroethylene (PCTFE) or ACLAR® layer 112, an EL panel layer 120, a PET layer 146, an aluminum foil layer 144, a PET layer 142, a PCB layer 160, a PSA layer 172, a CPL 170, a PET layer 186, an aluminum foil layer 144, a PET layer 182, and a PET layer 190. The PET layer 146, the aluminum foil layer 144, and the PET layer 142 may form the shield 140 in an embodiment. The PET layer 186, the aluminum foil layer 184, and the PET layer 182 may form a shield 180 in an embodiment.

In an embodiment the polychlorotrifluoroethylene (PCTFE) or ACLAR® layer 112 coupled to the EL panel 120 via a heat seat adhesive (“HSA”). The PET layer 114 is about 10 millimeters and coupled to the ACLAR layer 112 via a HSA. The aluminum foil layer 144 may be coupled to the PET layer 146 via a pressure set adhesive (PSA) and to the PET layer 142 via a PSA. The CPL 170 may be formed of Neoprene® or polychloroprene of about 0.063 inch in thickness and coupled to the PCB via the PSA layer 172. The aluminum foil layer 184 may be coupled to the PET layer 186 and the PET layer 182 via a HSA. The PET layer 190 may be about 10 millimeter in thickness and coupled to the shield 180 via a HSA.

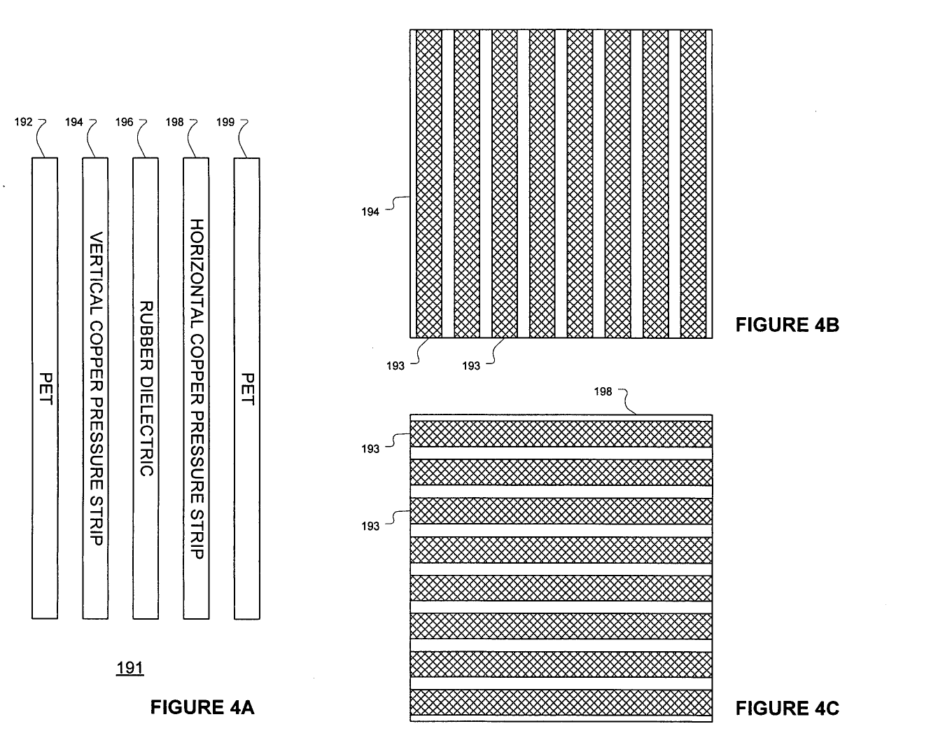

In an embodiment the electronic lighting panel may include a pressure sensitive architecture 191 in place of the PET layer 190 as shown in FIG. 4A according to various embodiments. As shown in FIG. 4A the pressure sensitive architecture 191 may include a horizontal metal strip layer 198 separated from a vertical metal strip layer 194 via a rubber dielectric layer 196. The layers 194, 196, and 198 may be encased in a first PET layer 192 and a second PET layer 199. In an embodiment the metal strips may be copper strips or other conductive metal.

FIG. 4B is a side view of a vertical sensing layer 194 of an electronic sensing architecture 191. As shown the layer 194 may include a plurality of metal strips 193. FIG. 4C is a side view of a horizontal sensing layer 198 of an electronic sensing architecture 191. As shown the layer 198 may also include a plurality of metal strips 193. In an embodiment only a single strip 193 of the horizontal layer 198 may be coupled to a signal at the same time as a strip 193 of the vertical layer 194. Further the remaining strips 193 of the horizontal layer 198 and the vertical layer 194 may be grounded to maximize a capacitance measurement of the active row and column of the horizontal layer 198 and the vertical layer 194.

FIG. 11 is a flow diagram illustrating a sensing algorithm 250 according to various embodiments. In the algorithm 250 a row and column from of the horizontal layer 198 and the vertical layer 194 may be selected (activity 252). The other rows and columns of the horizontal layer 198 and the vertical layer 194 may be grounded (activity 254). Then a signal may be applied to the sensor array formed by the horizontal layer 198 and the vertical layer 194 (activity 256). Then the signal may be sampled (activity 258). In an embodiment the signal capacitance may be measured or sampled. The algorithm may repeat activities 252, 254, 256, 258 until all combinations have been sampled (activity 262).

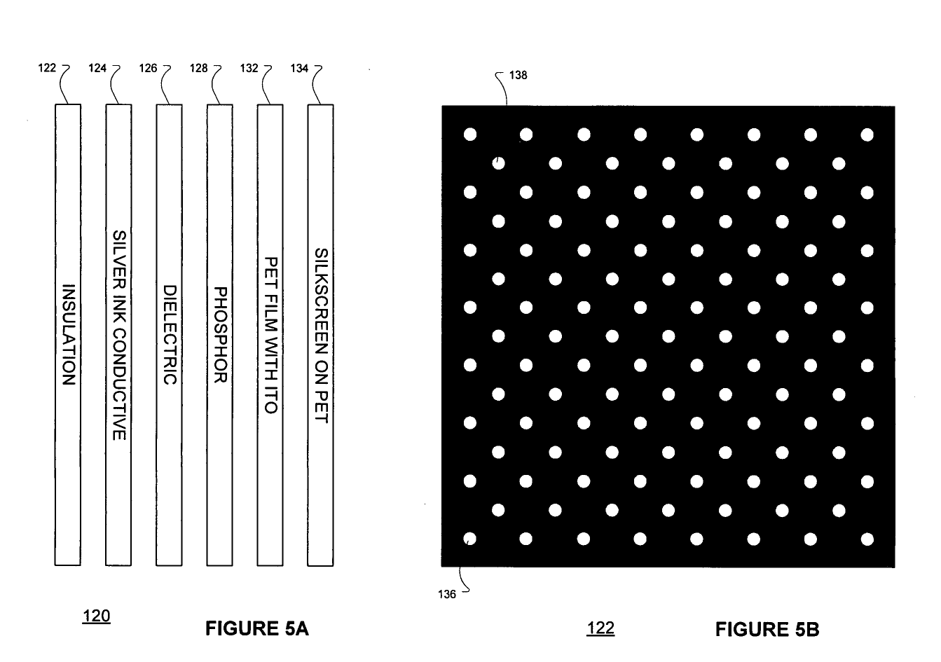

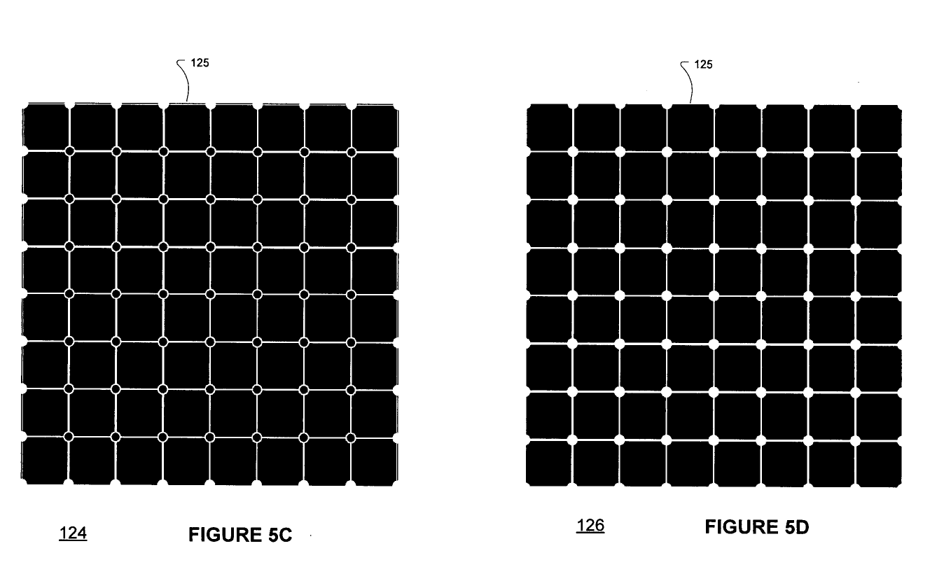

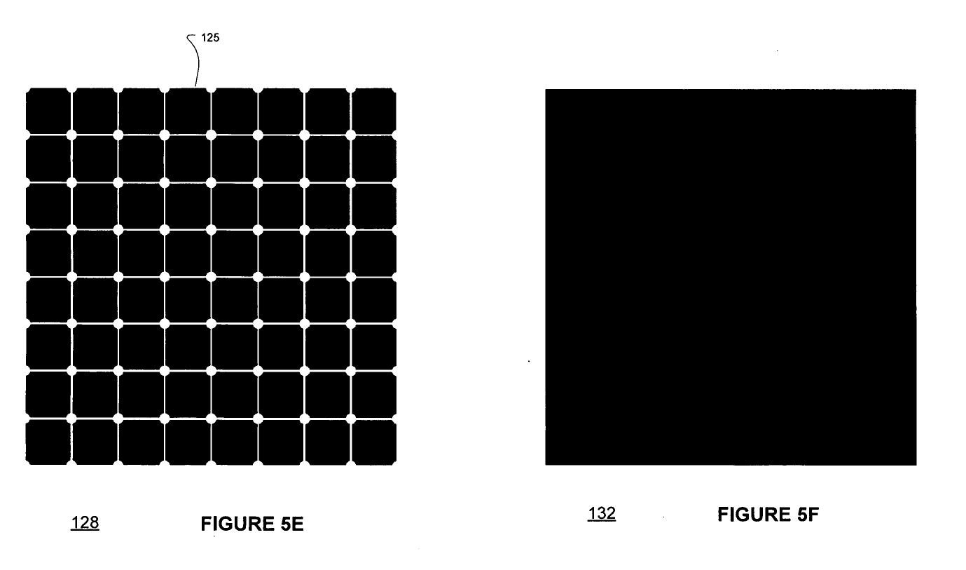

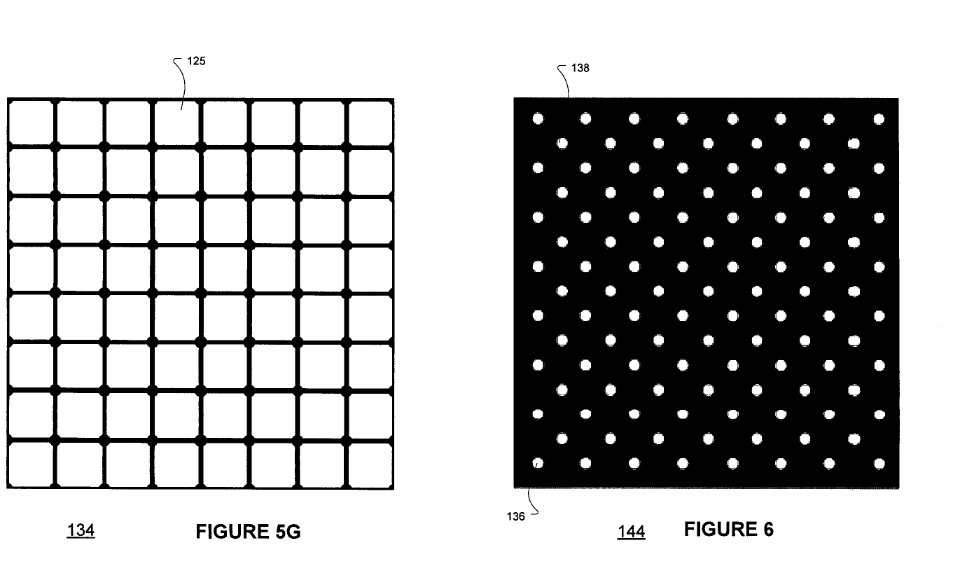

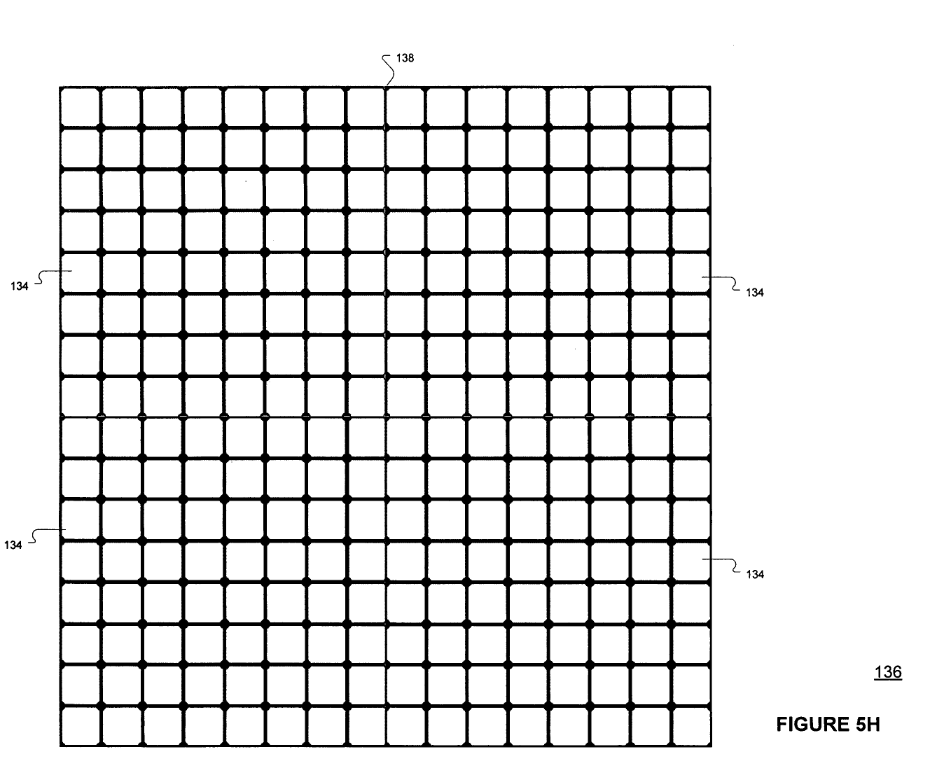

FIG. 5A is a side view of layers of a multi-celled electroluminescent (“EL”) architecture 120 according to various embodiments. The EL architecture 120 may include an insulation layer 122, a silver ink conductive layer 124, a dielectric layer 126, a phosphor layer 128, a PET film with ITO layer 132, and a silkscreen on PET layer 134. FIG. 5G is a front view of a silkscreen on polyethylene terephthalate (“PET”) layer 134 of a multi-celled EL architecture 120. As shown in FIG. 5G the EL panel 120 is divided into a plurality of cells for pixels 125. In an embodiment the cells 125 may be uniform.

FIG. 5B is a front view of an insulation layer 122 of a multi-celled electroluminescent (“EL”) architecture 120. The insulation layer 122 includes an opening 136 to each cell via the silver ink conductive layer 124. The insulation layer 122 may further include openings 138 to a common electrode formed by the PET film with ITO layer 132. In an embodiment the EL panel 120 includes sixty four cells 125 and sixteen common electrodes.

FIG. 5C is a front view of a silver ink conductive layer 124 of a multi-EL architecture 120. The silver ink conductive layer 124 includes a number of cells 125 and an opening to one or more points on the PET film with ITO layer 132. FIG. 5D is a front view of a dielectric layer 126 of a multi-celled EL architecture 120. The dielectric layer 126 also includes a number of cells 125 and an opening to one or more points on the PET film with ITO layer 132. FIG. 5E is a front view of a phosphor layer 128 of a multi-celled EL architecture 120. The phosphor layer 128 also includes a number of cells 125 and an opening to one or more points on the PET film with ITO layer 132. In an embodiment the openings to the one or more openings to the PET film with the ITO layer 132 in the silver ink conductive layer 124, the dielectric layer 126, and the phosphor layer 128 coincide. Also the cell or pixel formations 125 in the silver ink conductive layer 124, the dielectric layer 126, the phosphor layer 128, and the silkscreen on PET layer 134 coincide.

In an embodiment the edges of each EL panel cell 125 are configured so that when another EL panel is placed adjacent an EL panel 120 on any side the cells boundaries appear uniform. FIG. 5H is a diagram of four EL panels 120 coupled together according to various embodiments. As shown in FIG. 5H the coupling of adjacent panels 120 at edge 138 is not substantially distinguishable from other cells 125 of EL panels 120.

FIG. 6 is a front view of an aluminum foil layer 144 of a shield architecture 140. As shown in FIG. 6 the shield 144 includes openings to the rear electrode 136 of each cell 125 and one or more openings 138 to the common front electrodes of the cells 125. In an embodiment the openings 138 to the one or more openings to the PET film with the ITO layer 132 (common front electrode for each cell or pixel 125) in the aluminum foil layer 144, the silver ink conductive layer 124, the dielectric layer 126, and the phosphor layer 128 coincide. Also the cell or pixel formations 125 in the silver ink conductive layer 124, the dielectric layer 126, the phosphor layer 128, the silkscreen on PET layer 134 coincide with the openings in the rear electrode 136 of each cell 125.

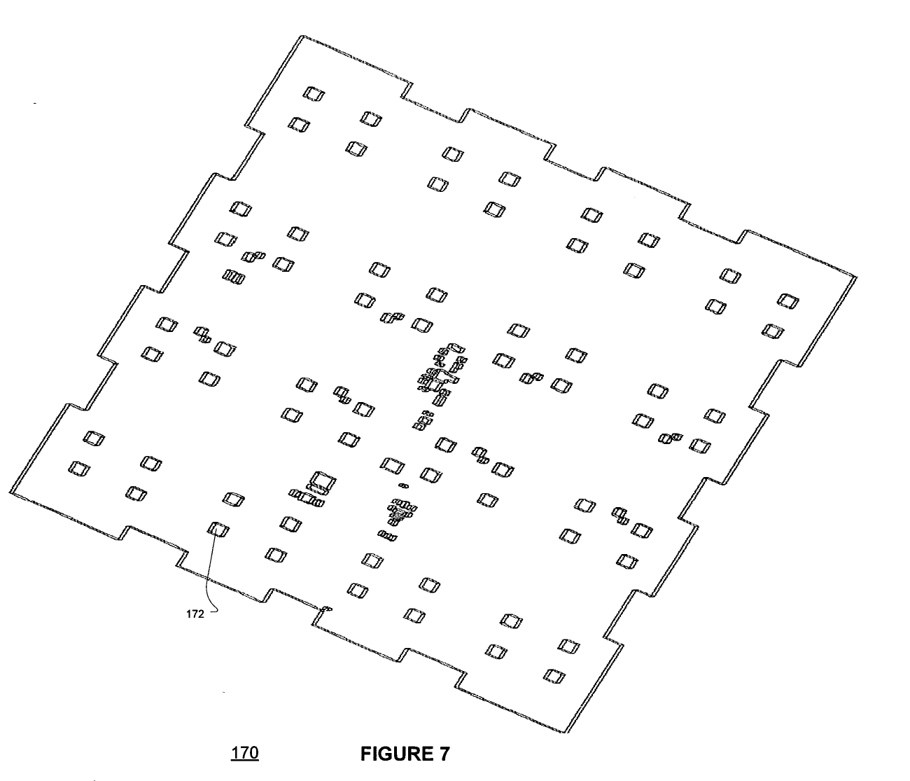

FIG. 7 is a component protection layer (CPL) 170 of an electronic lighting panel architecture 100. In an embodiment the PCB 160 may include one or more integrated circuits (IC) that a vertical thickness. The CPL 170 may have an opening 172 that corresponds to each raised IC on the PCB to prevent potential damage to each IC when the EL architecture 100 is formed.

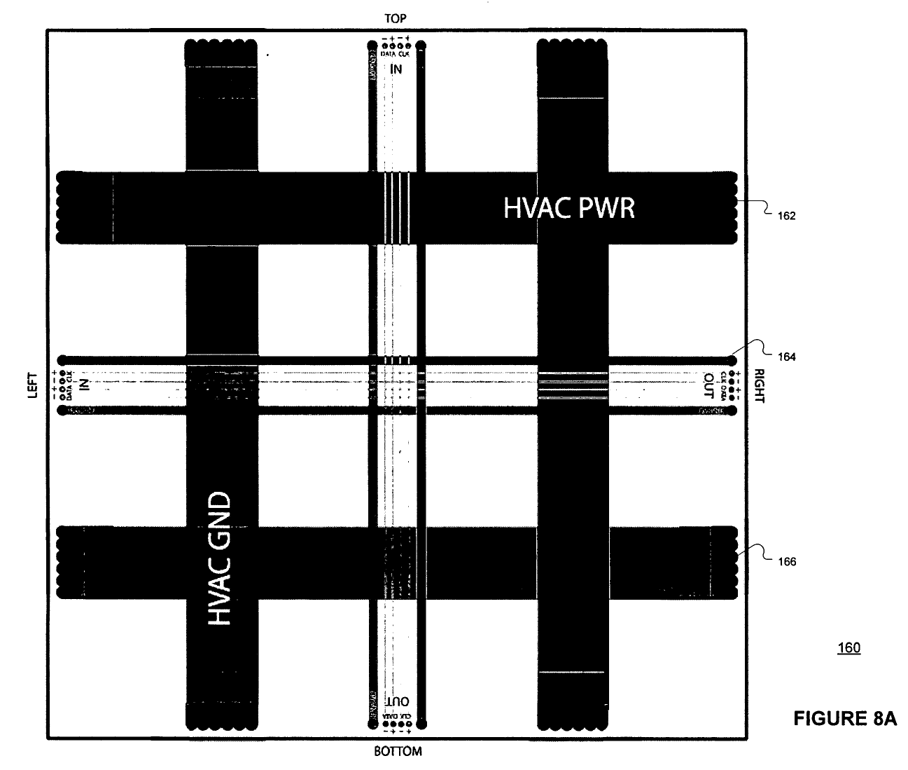

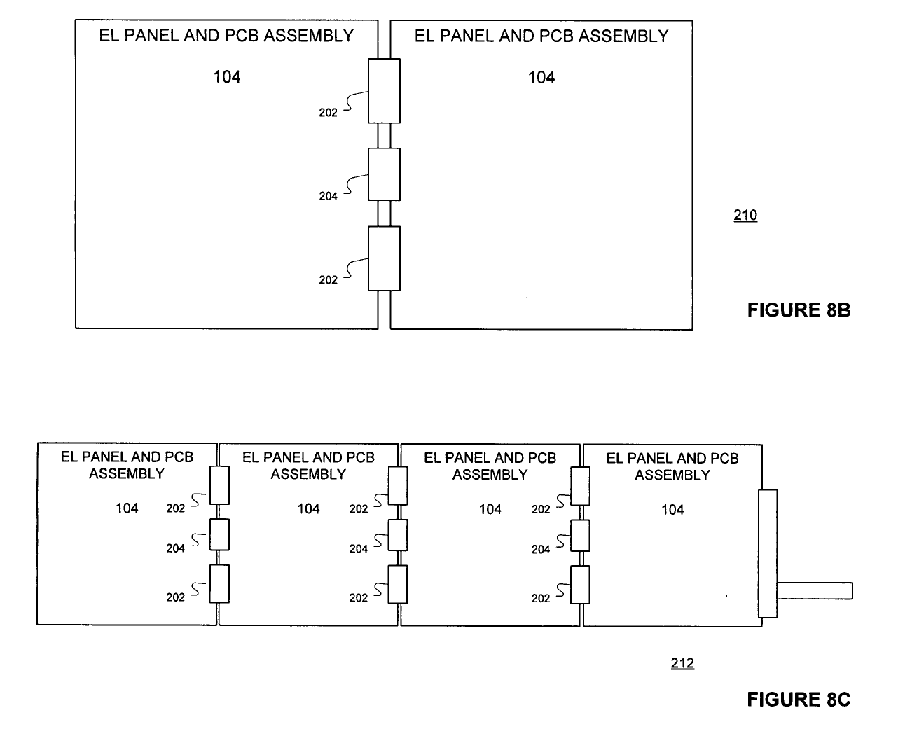

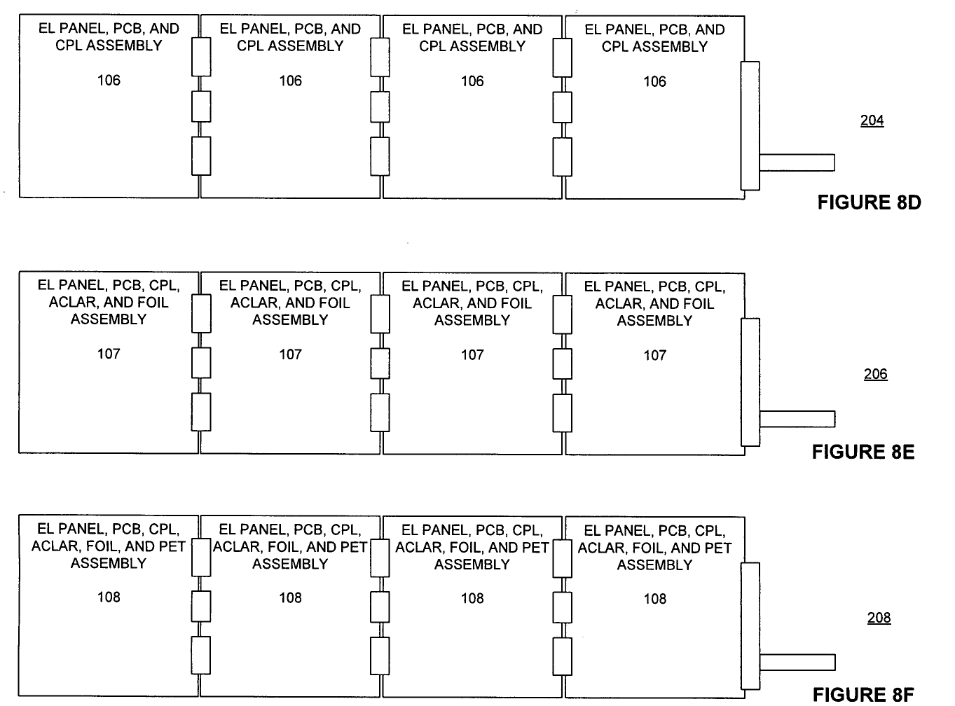

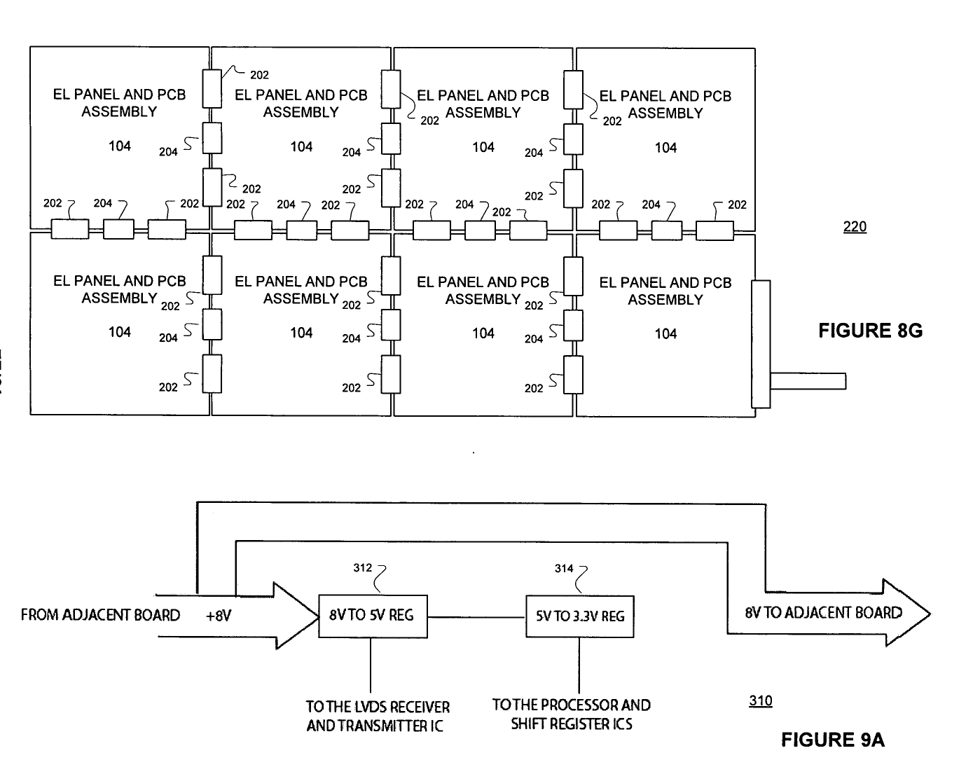

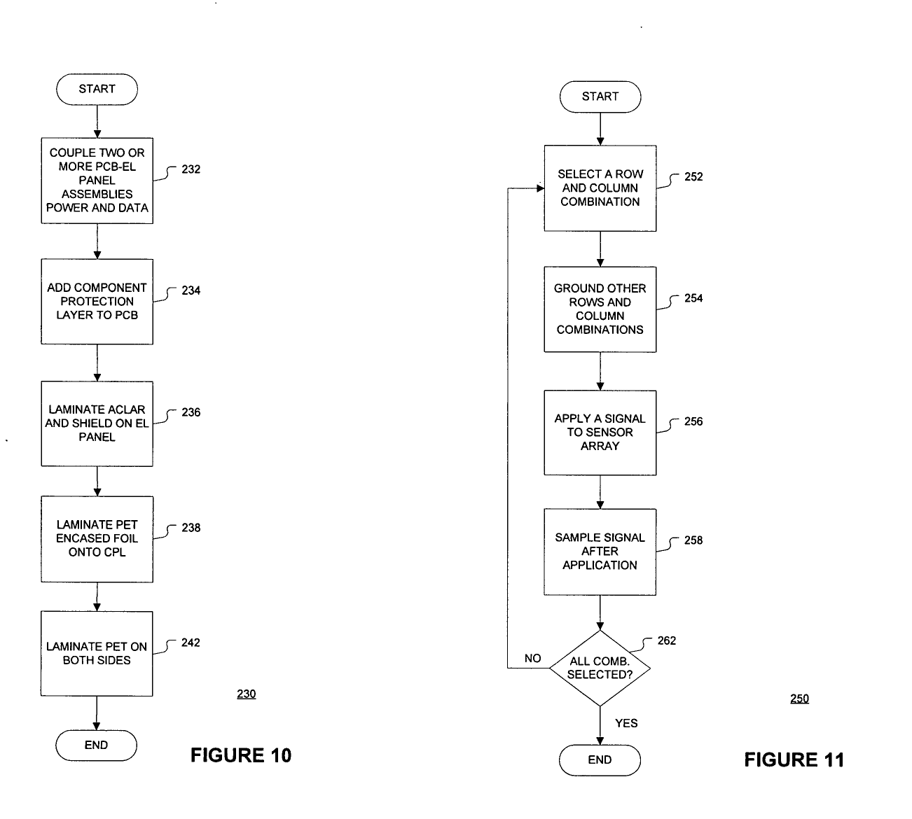

In an embodiment it may be desirable to couple two or more EL panels 100 together to form a larger, overall panel. FIG. 10 is a flow diagram illustrating a panel coupling algorithm 230 according to various embodiments. In the algorithm 230, two or more EL panels may be first electrically coupled via the PCB 160. FIG. 8A is a partial view of a top section of a printed circuit board (“PCB”) 160 of an electronic lighting panel architecture 100 depicting the power circuitry.

As shown in FIG. 8A the power circuitry includes a positive, high voltage alternating current (HVAC) path 162, a HVAC ground path 166, and a data path 164. In an embodiment the HVAC positive path 162, HVAC ground path 166, and data path 164 may be repeated on each side of the PCB 160 so adjacent panels 100 may be coupled. FIG. 8B is a partial view of two EL panels having PCB panels electrically coupled according to various embodiments. As shown in FIG. 8B, the HVAC positive paths 162 between two panels may be coupled via a metal conductor 202. The HVAC ground path 166 between two paths may be coupled via another metal conductor 202 and the data path 164 between the two panels may be coupled via a third metal conductor 204.

FIG. 8C is a partial view of four EL panels coupled to PCB panels electrically coupled according to various embodiments. Each adjacent panel may be coupled together electrically via the conductors 202, 204 as shown in FIG. 8C. In algorithm 230 a CPL layer 170 may be applied over the PCB 160 of the combined panels (activity 234). FIG. 8D is a partial view of four EL panels coupled to PCB panels electrically coupled and covered with a CPL layer 170 according to various embodiments. A single, continuous CPL layer 170 may be applied over the entire set (204).

In the algorithm 230 a ACLAR® layer 112 and shield 140 may be applied over the EL panels FIG. 8E is a partial view of four EL panels coupled to PCB panels electrically coupled and covered with a CPL, polychlorotrifluoroethylene (PCTFE) or ACLAR®, and FOIL layer according to various embodiments forming the architecture 206. Algorithm 230 may further laminate a shield 180 over the CPL 170 (activity 238) to form the architecture shown in FIG. 8E. The algorithm 230 may further laminate a PET layer 190, 114 on both sides of the architecture 206 to form the architecture 208 shown in FIG. 8F. The algorithm 230 may used to form panels of other configurations such as shown in FIG. 8G. FIG. 8G is a partial view of eight EL panels (220) coupled to PCB panels electrically coupled according to various embodiments.

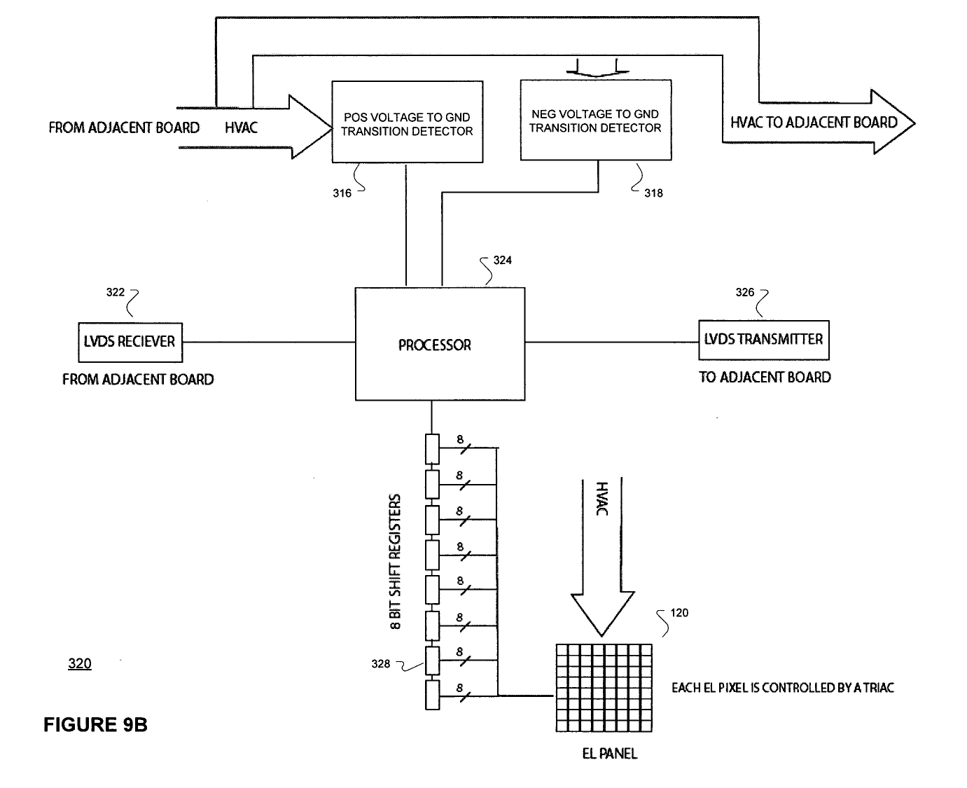

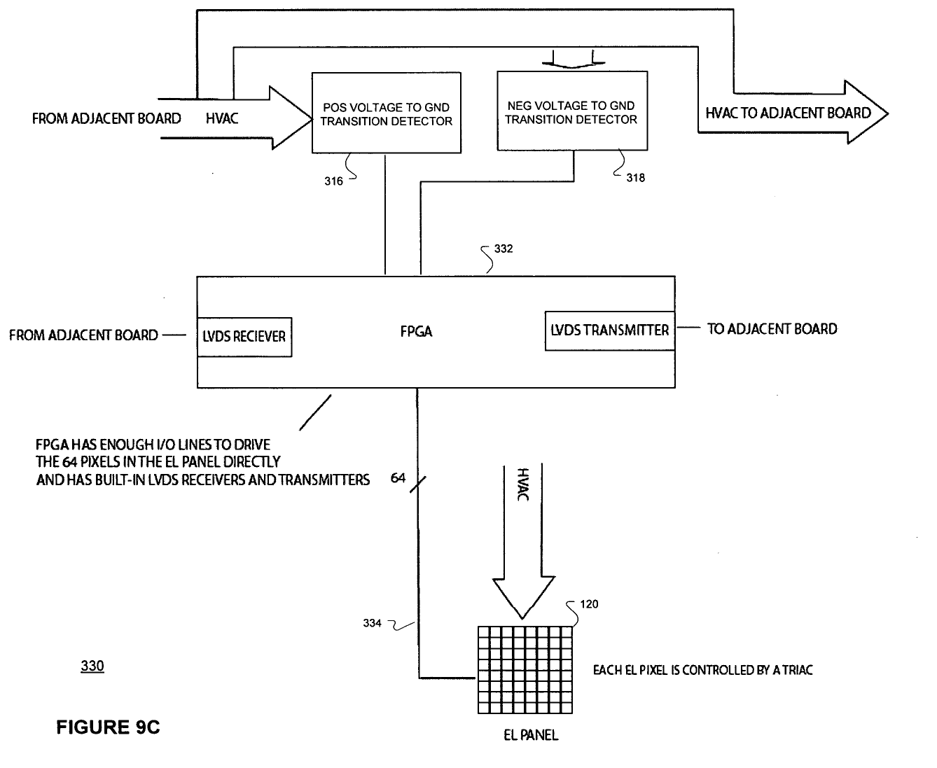

FIG. 9A is a diagram of low power transmission for PCB 160 of an electronic lighting panel architecture 310 according to various embodiments. In an embodiment data is communicated to the PCB 160 via a Low-Voltage Differential Signaling (LVDS) protocol which is known to those of skill in the art. A PCB 160 may receive an 8 volt (V) signal and convert the 8V signal to a 5V signal. The 5V signal may be supplied to an LVDS receiver and transmitter. Each PCB 160 may further convert the 5V signal into 3.3V signal. The 3.3V signal may be coupled to a processor (324 in FIG. 9B) and shift register ICs (328 in FIG. 9B) of the PCB 160.

FIG. 9B is a diagram of high power transmission for a PCB and processor configuration 320 of an electronic lighting panel architecture 100 according to various embodiments. The PCB 160 of the configuration 320 may include a positive voltage to ground transition detector 316 and a negative voltage to ground transition detector 318, main processor 324, LVDS receiver 322, LVDS transmitter 326, and eight, 8-bit shift registers 328. The processor uses the detectors 316, 318 to determine when to control operation of the shift registers 328 and process the LVDS data.

FIG. 9C is a diagram of another high power transmission for a PCB and processor configuration 330 of an electronic lighting panel architecture 100 according to various embodiments. In the configuration 330 the PCB 160 includes a Field Programmable Gate Array (FPGA) that includes the functionality of the processor 324, LVDS receiver 322, LVDS transmitter 326, and eight, 8-bit shift registers 328. The FPGA 332 reduces the number of chipsets on the PCB 160 in an embodiment and may reduce the number of openings 172 in a corresponding CPL 170.

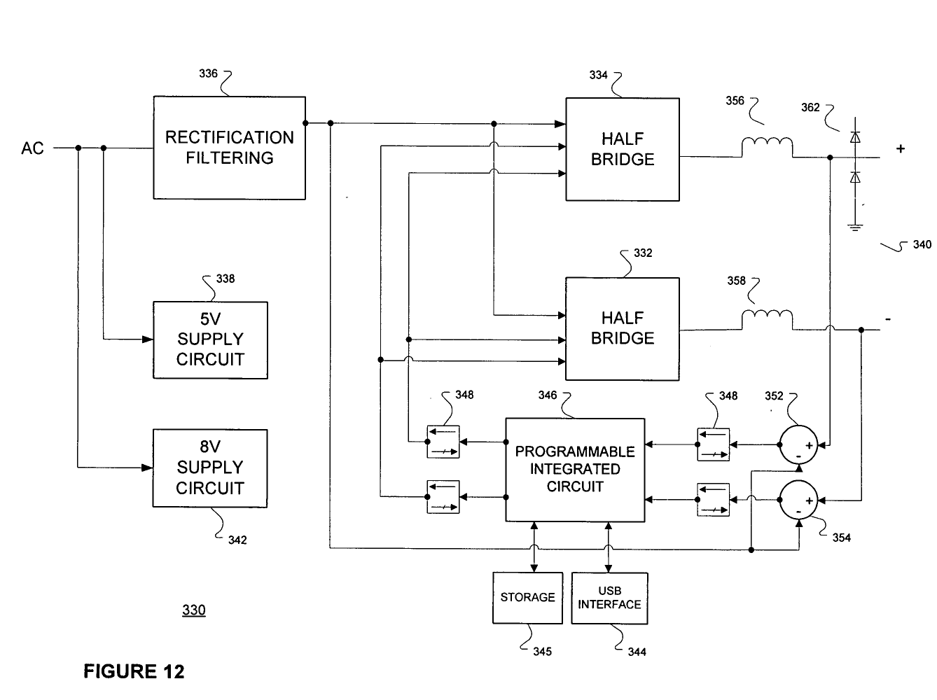

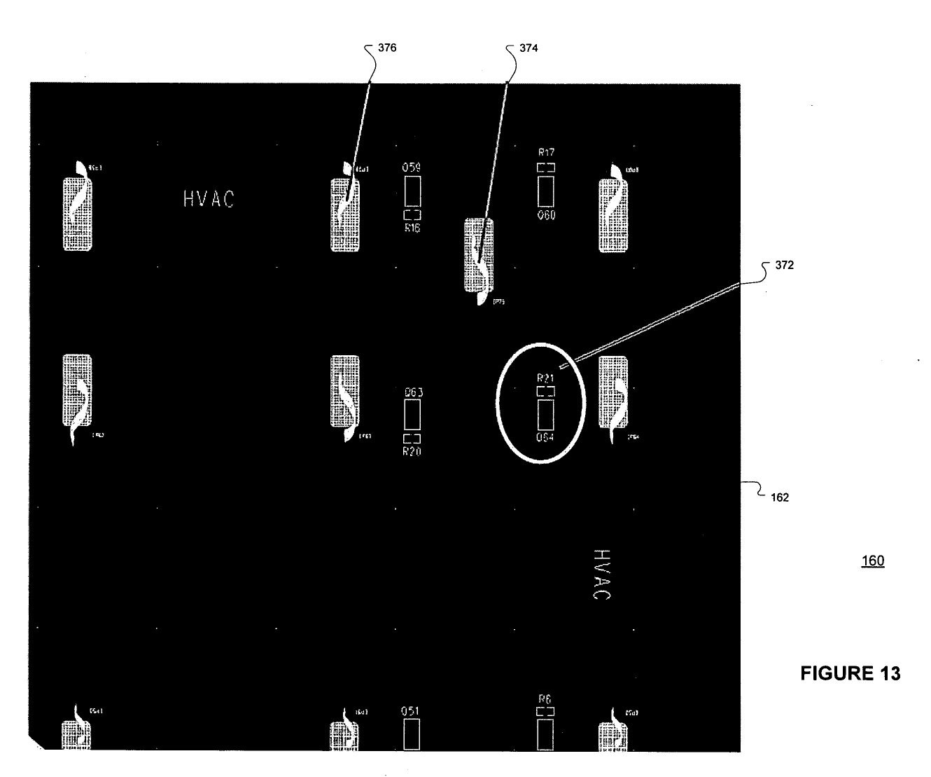

FIG. 12 is a block diagram of a power supply 330 according to various embodiments. The power supply 330 includes a rectification filtering circuit 336, a 5V supply circuit 338, a 8V supply circuit 342, a first half bridge 334, a second half bridge 332, a programmable integrated circuit (PIC) 346, four opto-isolators 348, a Universal Serial Bus (USB) interface 344, a first summer 352, a second summer 354, a first inductor 356, a second inductor 358, and two diodes 362. In an embodiment the power supply 330 generates a 170 VAC at 1100 Hz at output 340 where the output 340 positive is coupled to the PCB HVAC 162 and the output 340 negative is coupled to the PCB HVAC 166.

In an embodiment the summers 352, 354 provide a feedback signal at 8V that is converted to a 5V signal via a pair of opto-isolators 348. The PIC 346 generates bias signals that control the amplification of the half bridges 332, 334. The PIC 346 generates 5V signals that are converted to 8V signals by opto-isolators 348. A user via the USB interface 344 may control the operation of the power supply by controlling or modifying the PIC 346. The power supply 330 may be coupled to one or more EL panels 100 while maintaining the voltage level at or about a desired, predetermined level.

FIG. 13 is a diagram of a section of PCB 160 including EL panel 120 power couplings according to various embodiments. The pad 376 may be coupled to a cell or pixel of the EL panel 120 via the opening 136 in the insulation layer 122 to the silver ink conductive layer 124. In an embodiment a single pad 376 of the PCB 160 is coupled to a single cell or pixel of the EL panel 120. In an embodiment each opening 136 may be vertically aligned with a respective pad 376 so the PCB 160 may be easily coupled to the EL panel 120 via a conductive, elastomeric glue including an isotopic glue.

The PCB board 160 may also include several pads 374 that may be coupled to the front, common electrode of the cells or pixels 125 of the EL panel 120 via the openings 138 in the insulation layer 122, the silver ink conductive layer 124, the dielectric layer 126, and the phosphor layer 128 to the PET film with ITO layer 132. In an embodiment sixteen pads 378 of the PCB 160 is coupled to the front, common electrode of the cells or pixels 125 of the EL panel 120 via the openings 138 in the insulation layer 122, the silver ink conductive layer 124, the dielectric layer 126, and the phosphor layer 128 to the PET film with ITO layer 132. In an embodiment each opening 138 may be vertically aligned with a respective pad 374 so the PCB 160 may be easily coupled to the EL panel 120 via a conductive, elastomeric glue including an isotopic glue. In an embodiment there may be a predetermined ratio of pixels or cells 125 to common electrode connections 374 to limit voltage drops over cells or pixels 125.

The PCB 160 may also include several pixel driver circuits 372 where each pixel or cell driver circuit regulates HVAC to a cell or pixel 125 of an EL panel 120 via the signals generated by the 8-bit shift registers 328 or FPGA 332 that generate a desired signal level for each cell or pixel 125. The PCB 160 may be flexible and thin, such as 3 mm. The other layers of the EL architecture 100 may also be flexible. Accordingly the EL architecture 100 may be flexible and substantially flexible so the architecture 100 may be rolled for storage or mounted on a curved surface.

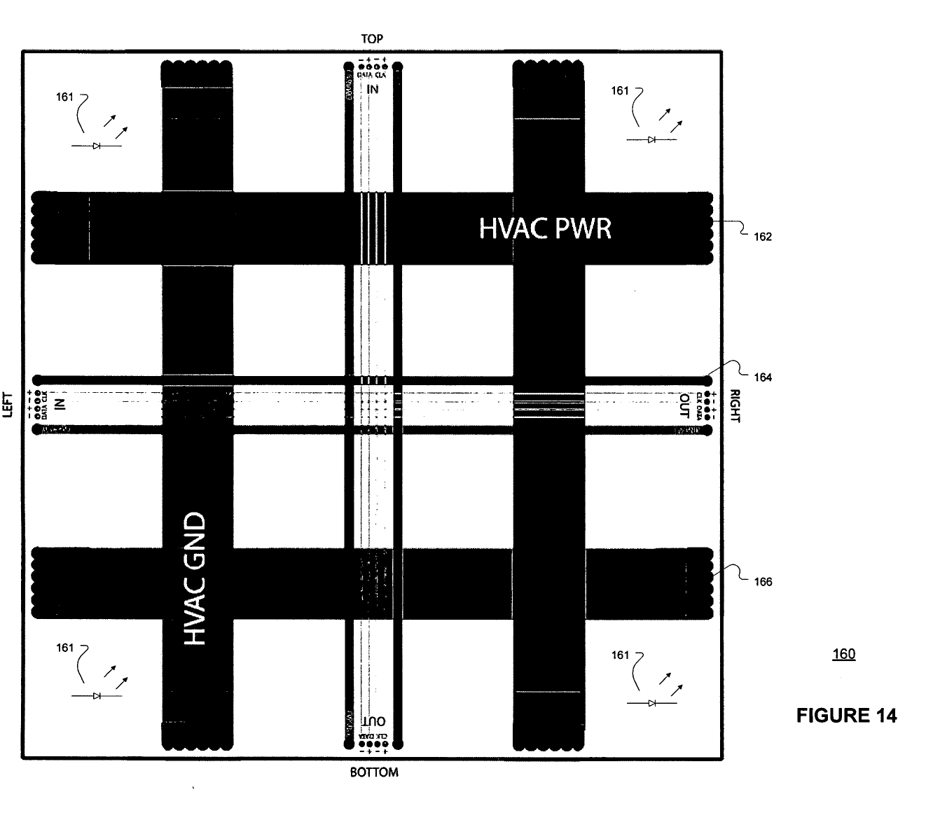

FIG. 14 is another partial view of a top section of a printed circuit board (“PCB”) 160 of an electronic lighting panel architecture 100. In this embodiment the PCB may include one or more environmental detection devices 161 including a photo-detector, an infrared sensor, a optical sensor, thermal sensor or other sensor. The sensor 161 may be used to measure ambient light on the panel architecture 100. An opening 136 or 138 may be coupled to the sensor 161 to provide a pathway for electromagnetic energy including photonic energy. The PCB 160 may communicate measured information from a sensor 161 to the controller 20, computer 90, controller 70, or power supply 50. The controller 20, computer 90, controller 70, or power supply 50 may employ the algorithm 420 to process sensor information including information from a PCB sensor 161 or external sensor including traffic signal information that may be provided by one or more traffic signal devices.

The algorithm 420 may monitor one or more sensor levels including external and PCB determined sensor levels (activity 422). The algorithm 420 may then determine whether the measured or calculated sensor data are within parameters. The sensor data may include light impingement information, nearby traffic activity, temperature data, and other measurable data. The algorithm 420 may modify the attributes or values of one or more cells or pixels 125 of one or more EL panels 120. In an embodiment the algorithm 420 may increase or decrease the intensity of one or more cells as a function of the light intensity on or nearby the cells. In an embodiment the algorithm 420 may stop, start, or limit animation of one or more cells as a function of the sensor data including traffic sensor information (activity 426). The algorithm 420 may then transmit the changed cell attributes to one or more PCB 160 of EL panels 120 (activity 428).

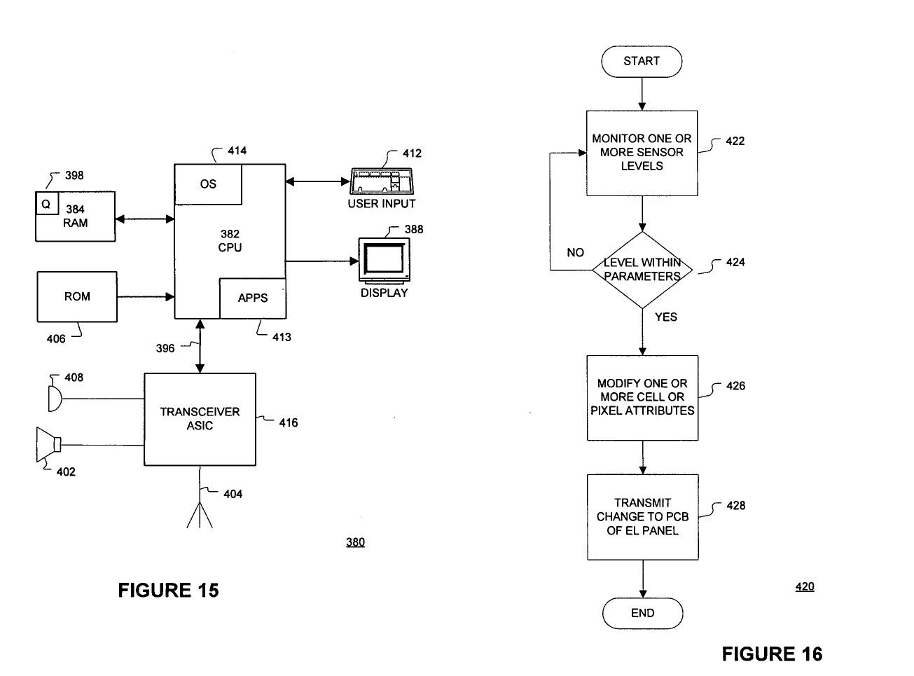

FIG. 15 is a block diagram of an article 380 according to various embodiments. The article 380 is shown in FIG. 15 that may be used in various embodiments as a part of the controller-power supply 20, computer system 90, or controller 70 where the article 380 may be any computing device including a personal data assistant, cellular telephone, laptop computer, or desktop computer. The article 380 may include a central processing unit (CPU) 382, a random access memory (RAM) 384, a read only memory (ROM”) 406, a display 388, a user input device 412, a transceiver application specific integrated circuit (ASIC) 416, a microphone 408, a speaker 402, and an antenna 404. The CPU 382 may include an OS module 414 and an application module 413. The RAM 384 may include a queue 398 where the queue 398 may store signal levels to be applied to one or more cells or pixels 125. The OS module 414 and the application module 413 may be separate elements. The OS module 414 may execute a computer system or controller OS. The application module 412 may execute the applications related to the control of the EL panel architecture 100.

The ROM 406 is coupled to the CPU 382 and may store the program instructions to be executed by the CPU 382, OS module 414, and application module 413. The RAM 384 is coupled to the CPU 382 and may store temporary program data, overhead information, and the queues 398. The user input device 412 may comprise an input device such as a keypad, touch pad screen, track ball or other similar input device that allows the user to navigate through menus in order to operate the article 380. The display 388 may be an output device such as a CRT, LCD or other similar screen display that enables the user to read, view, or hear documents or displays 20, 70, 90.

The microphone 408 and speaker 402 may be incorporated into the device 380. The microphone 408 and speaker 402 may also be separated from the device 380. Received data may be transmitted to the CPU 382 via a serial bus 396 where the data may include cell or pixel information for one or more cells or pixels 125 of an EL panel 120. The transceiver ASIC 416 may include an instruction set necessary to communicate data, screens, or pixel information in architecture 40. The ASIC 416 may be coupled to the antenna 404 to communicate wireless messages, pages, and cell or pixel information within the architecture 40. When a message is received by the transceiver ASIC 416, its corresponding data may be transferred to the CPU 382 via the serial bus 396. The data can include wireless protocol, overhead information, and data to be processed by the device 380 in accordance with the methods described herein.

Any of the components previously described can be implemented in a number of ways, including embodiments in software. Any of the components previously described can be implemented in a number of ways, including embodiments in software. Thus, the controller-power supply 20, computer 90, controller 70, power supply 50, PCB 160, detectors 316, 318, processor 324, LVDS receiver 322, LVDS transmitter 326, 8-bit shift registers 328, FPGA 332, and pixel driver circuit 372, may all be characterized as “modules” herein. The modules may include hardware circuitry, single or multi-processor circuits, memory circuits, software program modules and objects, firmware, and combinations thereof, as desired by the architect of the architecture 10, 40 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An electronic lighting system, including:
a first panel including at least two separately energizable first cells where each cell generates light by the application of energy to one of the separately energizable first cells;
a second panel including at least two separately energizable second cells where each cell generates light by the application of energy to one of the separately energizable second cells; and
an electrically conductive element coupling power between the first panel and the second panel.

2. The electronic lighting system of claim 1, wherein the first panel and second panel are substantially planar and flexible in the planar axis.

3. The electronic lighting system of claim 1, wherein the at least two separately energizable first cells have one of a common front and rear electrode.

4. The electronic lighting system of claim 1, wherein the at least two first cells and the at least two second cells have substantially similar surface areas.

5. The electronic lighting system of claim 3, wherein the at least two separately energizable first cells have a different one of the other of the common front and the rear electrode.

6. The electronic lighting system of claim 5, wherein the at least two first cells surface areas and the at least two second cells surface areas are located substantially on the planar surface.

7. The electronic lighting system of claim 1, further comprising a first substantially planar printed circuit board laminated to the first panel and a second substantially planar printed circuit board laminated to the second panel.

8. The electronic lighting system of claim 7, further comprising a first substantially planar electromagnetic shield between the first printed circuit board and the first panel and a second substantially planar electromagnetic shield between the second printed circuit board (PCB) and the second panel.

9. The electronic lighting system of claim 8, wherein the first PCB has at least one surface mounted device and second PCB has at least one surface mounted device and further comprising a component protection layer (CPL) laminated to the first PCB and the second PCB, the CPL including a cutout for the first PCB at least one surface mounted device and a cutout for the second PCB at least one surface mounted device.

10. The electronic lighting system of claim 9, further comprising a laminate layer substantially over the CPL.

11. An electronic lighting method, including electrically coupling power between a first panel including at least two separately energizable first cells where each cell generates light by the application of energy to one of the separately energizable first cells and a second panel including at least two separately energizable second cells where each cell generates light by the application of energy to one of the separately energizable second cells via at least one electrically conductive element.

12. The electronic lighting method of claim 11, wherein the first panel and the second panel are substantially planar and flexible in the planar axis.

13. The electronic lighting method of claim 11, wherein the at least two separately energizable first cells have one of a common front and rear electrode.

14. The electronic lighting method of claim 11, wherein the at least two first cells and the at least two second cells have substantially similar surface areas.

15. The electronic lighting method of claim 13, wherein the at least two separately energizable first cells have a different one of the other of the common front and the rear electrode.

16. The electronic lighting method of claim 15, wherein the at least two first cells surface areas and the at least two second cells surface areas are located substantially on the planar surface.

17. The electronic lighting method of claim 11, further comprising laminating a first substantially planar printed circuit board laminated to the first panel and laminating a second substantially planar printed circuit board to the second panel.

18. The electronic lighting method of claim 17, further comprising inserting a first substantially planar electromagnetic shield between the first printed circuit board and the first panel and inserting a second substantially planar electromagnetic shield between the second printed circuit board (PCB) and the second panel.

19. The electronic lighting method of claim 18, wherein the first PCB has at least one surface mounted device and second PCB has at least one surface mounted device and further comprising laminating a component protection layer (CPL) to the first PCB and the second PCB, the CPL including a cutout for the first PCB at least one surface mounted device and a cutout for the second PCB at least one surface mounted device.

20. The electronic lighting method of claim 19, further comprising a laminating an elastomer layer substantially over the CPL.
